(19) United States
(12) Patent Application Publication
(10) Pub. No.: US 2004/0127653 A1
(43) Pub. Date: Jul. 1, 2004

(54) Polycarbonate/polyester copolymer blends and process for making thereof

(75) Inventors: Donald Howard Ellington, Evansville, IN (US); Shoen (Michael) Davis, Mount Vernon, IN (US); Peter H. Th. Vollenberg, Evansville, IN (US); Gabrie Hoogland, Breda (NL); Abbas-Alli Ghudubhai Shaikh, Bangalore (IN); Ganesh Kannan, Bangalore (IN); Vishvajit Chandrakant Juikar, Bangalore (IN); Rajashekhar Shiddappa Totad, Bangalore (IN); Paul Honigfort, Gaithersburg, MD (US); Manickam Jayakannan, Kerala (IN)

Correspondence Address: Robert E. Walter, GE Plastics, One Plastics Avenue, Pittsfield, MA, 01201, US

(73) Assignee: General Electric Company

(21) Appl. No.: 10/625,355

(22) Filed: Jul. 23, 2003

Related U.S. Application Data
(60) Provisional application No. 60/406,747, filed on Aug. 30, 2002.

(51) Int. Cl. C08F 20/00

(52) U.S. Cl. 525/439

(57) ABSTRACT

Disclosed are transparent polycarbonate/polyester compositions with excellent balance of improved physical properties, and a single-stage melt extrusion process for making such compositions wherein an acidic stabilizing additive is added down-stream from the polycarbonate/polyester melt reaction location.

### CROSS REFERENCE TO RELATED APPLICATIONS

This application claims priority to U.S. Provisional Application Serial No. 60/406747 filed on Aug. 30, 2002, which is incorporated herein by reference in its entirety.

### FIELD OF THE INVENTION

The present invention relates to transparent thermoplastic resin compositions, and, more particularly, to transparent compositions containing a blend of a polyester resin and a polycarbonate resin.

### BACKGROUND

Transparent blends of polycarbonate (PC) and polyesters have attractive properties such as toughness and chemical resistance. The miscibility of PC with the (aliphatic) polyesters gives the blends the clarity needed, but this is restricted to aliphatic polyesters such as poly(cyclohexane dimethanol cyclohexane dicarboxylate) (PCCD) or a glycolized semi aliphatic polyester such as PCTG. PCT patent application no. WO 02/38675 discloses a thermoplastic composition comprising PC, PCCD, and an impact modifier.

U.S. Pat. No. 4,188,314, U.S. Pat. No. 4,125,572; U.S. Pat. Nos. 4,391,954; 4,786,692; 4,897,453, 5,478,896, U.S. Pat. No. 4,786,692 and U.S. Pat. No. 5,478,896 relate to blends of an aromatic polycarbonate and poly cyclohexane dimethanol phthalate. U.S. Pat. No. 4,125,572 relates to a blend of PC, polybutylene terephthalate (PBT) and an aliphatic/cycloaliphatic iso/terephthalate resin. The patents, U.S. Pat. No. 5,194,523 and U.S. Pat. No. 5,207,967 describe the blending of amorphous polyester PCT with bisphenol-A polycarbonate to obtain blends with improved low temperature impact strength and processability.

U.S. Pat. No. 4,506,442 discloses a PC/polyester blend and an uncatalyzed process for preparing the blend by melt reactions between PC and polyesters for a long period of time (mixing time of up to 60 minutes). U.S. Pat. No. 5,055,531 discloses PC/polyester blends by reactive extrusion using catalysts, specifically metal based catalysts, in an amount of about 0.0005 to about 0.5 percent by weight, wherein a second extrusion step is needed to quench the catalyst used in the reaction. U.S. Pat. No. 6,281,299 discloses a process for manufacturing transparent polyester/polycarbonate compositions, wherein the polyester is fed into the reactor after bisphenol A is polymerized to a polycarbonate.

### SUMMARY OF THE INVENTION

According to an embodiment, the prepared transparent polycarbonate/polyester resin compositions and articles made from them have low temperature impact resistance, improved chemical resistance compared to polycarbonate, and good melt processability.

According to an embodiment, such molding compositions may be prepared by a one-step reactive extrusion process for the manufacture of transparent polycarbonate/polyester blends, wherein the down-stream feeding of a catalyst quencher eliminates the need of a second pass through.

According to an embodiment, which requires a minimal amount of catalyst, surprisingly produces transparent polycarbonate/polyester blends of desired and improved properties, including hydrolytic stability and melt viscosity stability.

### DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic diagram of the extrusion process in the prior art.

FIG. 2 illustrates a schematic diagram of the extrusion process of the present invention, allowing downstream feeding of the catalyst quencher.

### DETAILED DESCRIPTION

The present invention may be understood more readily by reference to the following detailed description of preferred embodiments of the invention and the examples included herein. In this specification and in the claims, which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein the term “polycarbonate” refers to polycarbonates incorporating structural units derived from one or more dihydroxy aromatic compounds and includes copolycarbonates and polyester carbonates.

The components of the transparent blend comprise an aromatic polycarbonate and a polyester component.

POLYCARBONATE COMPONENT. A component of the blend of the invention is an aromatic polycarbonate. The aromatic polycarbonate resins suitable for use in the present invention, methods of making polycarbonate resins and the use of polycarbonate resins in thermoplastic molding compounds are well known in the art, see, generally, U.S. Pat. Nos. 3,169,121, 4,487,896 and 5,411,999, the respective disclosures of which are each incorporated herein by reference.

Polycarbonates useful in the invention comprise the divalent residue of dihydric phenols, Ar′, bonded through a carbonate linkage and are preferably represented by the general formula I:

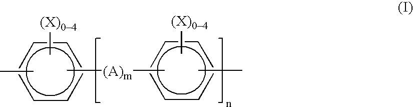

wherein A is a divalent hydrocarbon radical containing from 1 to about 20 carbon atoms or a substituted divalent hydrocarbon radical containing from 1 to about 20 carbon atoms; each X is independently selected from the group consisting of hydrogen, halogen, and a monovalent hydrocarbon radical such as an alkyl group of from 1 to about 8 carbon atoms, an aryl group of from 6 to about 18 carbon atoms, an arylalkyl group of from 7 to about 14 carbon atoms, an alkoxy group of from 1 to about 8 carbon atoms; and m is 0 or 1 and n is an integer of from 0 to about 5 and may be a single aromatic ring like hydroquinone or resorcinol, or a multiple aromatic ring like biphenol or bisphenol A.

Aromatic polycarbonate resins are, in general, prepared by reacting a dihydric phenol, e.g., 2,2-bis-(4-hydroxyphenyl) propane (also known as “bisphenol A”), 2,2-bis(3,5-dimethyl-4-hydroxyphenyl)propane, bis(2-hydroxyphenyl) methane, bis(4-hydroxyphenyl)methane, 2,6-dihydroxy naphthalene, hydroquinone, 2,4′-dihydroxyphenyl sulfone and 4, 4′-dihydroxy-3, 3-dichlorophenyl ether, with a carbonate precursor, e.g., carbonyl bromide and carbonyl chloride, a halogen formate, a bishaloformate of a dihydric phenol or a carbonate ester, e.g., diphenyl carbonate, dichlorophenyl carbonate, dinaphthyl carbonate, phenyl tolyl carbonate and ditolyl carbonate. In one embodiment the polycarbonate resins could be at least one selected from the group consisting of dihydric phenol ethers such as bis(4-hydroxyphenyl)ether, bis(3,5-dichloro-4-hydroxyphenyl)ether; p,p′-dihydroxydiphenyl and 3,3′-dichloro-4,4′-dihydroxydiphenyl; dihydroxyaryl sulfones such as bis(4-hydroxyphenyl)sulfone, bis(3,5-dimethyl-4-hydroxyphenyl)sulfone, dihydroxy benzenes such as resorcinol, hydroquinone, halo- and alkyl-substituted dihydroxybenzenes such as 1,4-dihydroxy-2,5-dichlorobenzene, 1,4-dihydroxy-3-methylbenzene; and dihydroxydiphenyl sulfides and sulfoxides such as bis(4-hydroxyphenyl)sulfide, bis(4-hydroxy-phenyl)sulfoxide and bis(3,5-dibromo-4-hydroxyphenyl)sulfoxide. A variety of additional dihydric phenols are available and are disclosed in U.S. Pat. Nos. 2,999,835, 3,038,365 and 3,153,008; all of which are incorporated herein by reference. It is, of course, possible to employ two or more different dihydric phenols or a combination of a dihydric phenol with a glycol.

The carbonate precursors are typically a carbonyl halide, a diarylcarbonate, or a bishaloformate. The carbonyl halides include, for example, carbonyl bromide, carbonyl chloride, and mixtures thereof. The bishaloformates include the bishaloformates of dihydric phenols such as bischloroformates of 2,2-bis(4-hydroxyphenyl)-propane, hydroquinone, and the like, or bishaloformates of glycol, and the like. While all of the above carbonate precursors are useful, carbonyl chloride, also known as phosgene, and diphenyl carbonate are preferred.

The polycarbonate may contain small amounts of polyfunctional compound component units. Useful polyfunctional compound component units include, for example, aromatic polyols such as phloroglucin and 1,2,4,5,-tetrahydroxybenzene; aliphatic polyols such as glycerin, trimethylolethane, trimethylolpropane and pentaerylthritol; aromatic polybasic acids such as trimellitic acid, trimesic acid and 3,3′,5,5′-tetracarboxydiphenyl; aliphatic polybasic acids such as butanetetracarboxylic acid; and oxypolycarboxylic acids such as tartaric acid and malic acid.

In one embodiment, the aromatic polycarbonate resin comprises one or more resins selected from linear aromatic polycarbonate resins, branched aromatic polycarbonate resins and poly(ester-carbonate) resins. In one embodiment of the present invention linear aromatic polycarbonates resins include, e.g., bisphenol A polycarbonate resin.

Suitable branched aromatic polycarbonates are made, e.g., by reacting a polyfunctional aromatic compound, e.g., trimellitic anhydride, trimellitic acid, trimesic acid, trihydroxy phenyl ethane or trimellityl trichloride, with a dihydric phenol and a carbonate precursor to form a branching polymer.

Suitable poly(ester-carbonate) copolymers are made, e.g., by reacting a difunctional carboxylic acid, terephthalic acid, 2,6-naphthalic acid, or a derivative of a difunctional carboxylic acid, e.g., an acid chloride, with a dihydric phenol and a carbonate precursor.

The preferred polycarbonates are preferably high molecular weight aromatic carbonate polymers have an intrinsic viscosity (as measured in methylene chloride at 25° C.) ranging from about 0.30 to about 1.00. deciliters per gram Polycarbonates may be branched or unbranched and generally will have a weight average molecular weight of from about 10,000 to about 200,000, preferably from about 20,000 to about 100,000 as measured by gel permeation chromatography. It is contemplated that the polycarbonate may have various known end groups.

The aromatic polycarbonates can be manufactured by any processes such as by reacting a dihydric phenol with a carbonate precursor, such as phosgene, a haloformate or carbonate ester in melt or solution. U.S. Pat. No. 4,123,436 describes reaction with phosgene and U.S. Pat. No. 3,153,008 describes a transesterification process.

Preferred polycarbonate will be made of dihydric phenols that result in resins having low birefringence for example dihydric phenols having pendant aryl or cup shaped aryl groups for example, phenyl-di(4-hydroxyphenyl) ethane (acetophenone bisphenol), diphenyl-di(4-hydroxyphenyl) methane (benzophenone bisphenol), 2,2-bis(3-phenyl-4-hydroxyphenyl) propane, 2,2-bis-(3,5-diphenyl-4-hydroxyphenyl) propane, bis-(2-phenyl-3-methyl-4-hydroxyphenyl) propane, 2,2′-bis(hydroxyphenyl)fluorine,1,1-bis(5-phenyl-4-hydroxyphenyl)cyclohexane, 3,3′-diphenyl-4,4′-dihydroxy diphenyl ether, 2,2-bis(4-hydroxyphenyl)-4,4-diphenyl butane, 1,1-bis(4-hydroxyphenyl)-2-phenyl ethane, 2,2-bis(3-methyl-4-hydroxyphenyl)-1-phenyl propane, 6,6′-dihdyroxy-3,3,3′,3′-tetramethyl-1,1′-spiro(bis)indane, (also called “SBI”), or dihydric phenols derived from spiro biindane of formula II:

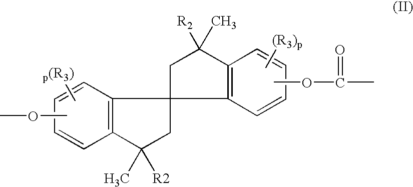

Other dihydric phenols which are typically used in the preparation of the polycarbonates are disclosed in U.S. Pat. Nos. 2,999,835, 3,038,365, 3,334,154 and 4,131,575. Branched polycarbonates are also useful, such as those described in U.S. Pat. Nos. 3,635,895 and 4,001,184. Polycarbonate blends include blends of linear polycarbonate and branched polycarbonate.

It is also possible to employ two or more different dihydric phenols or a copolymer of a dihydric phenol with an aliphatic dicarboxylic acids like; dimer acids, dodecane dicarboxylic acid, adipic acid, azelaic acid in the event a carbonate copolymer or interpolymer rather than a homopolymer is desired for use in the preparation of the polycarbonate mixtures of the invention. Most preferred are aliphatic C5 to C12 diacid copolymers. Units derived from SBI and its 5-methyl homologue are preferred, with SBI being most preferred.

In yet another, the polycarbonate resin is a linear polycarbonate resin that is derived from bisphenol A and phosgene. In an alternative embodiment, the polycarbonate resin is a blend of two or more polycarbonate resins.

The aromatic polycarbonate may be prepared in the melt, in solution, or by interfacial polymerization techniques well known in the art. For example, the aromatic polycarbonates can be made by reacting bisphenol-A with phosgene, dibutyl carbonate or diphenyl carbonate. Such aromatic polycarbonates are also commercially available. In one embodiment, the aromatic polycarbonate resins are commercially available from General Electric Company, e.g., LEXAN™ bisphenol A-type polycarbonate resins.

POLYESTER COMPONENT. Methods for making polyester resins and the use of polyester resins in thermoplastic molding compositions are known in the art. Conventional polycondensation procedures are described in the following, see, generally, U.S. Pat. Nos. 2,465,319, 5,367,011 and 5,411,999, the respective disclosures of which are each incorporated herein by reference.

Suitable polyester resins include crystalline polyester resins such as polyester resins derived from an aliphatic or cycloaliphatic diol, or mixtures thereof, containing from 2 to about 10 carbon atoms and at least one aromatic dicarboxylic acid. Preferred polyesters are derived from an aliphatic diol and an aromatic dicarboxylic acid and have repeating units according to structural formula (III)

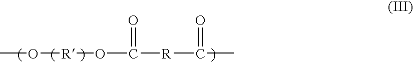

wherein: R′ is an alkyl radical compromising a dehydroxylated residue derived from an aliphatic or cycloaliphatic diol, or mixtures thereof, containing from 2 to about 10 carbon atoms

R is an aryl radical comprising a decarboxylated residue derived from an aromatic dicarboxylic acid.

Examples of aromatic dicarboxylic acids from which the decarboxylated residue R may be derived are acids that contain a single aromatic ring per molecule such as, e.g., isophthalic or terephthalic acid, 1,2-di(p-carboxyphenyl)ethane, 4,4′-dicarboxydiphenyl ether, 4,4′- bisbenzoic acid and mixtures thereof, as well as acids contain fused rings such as, e.g., 1,4- or 1,5-naphthalene dicarboxylic acids. In a preferred embodiment, the dicarboxylic acid precursor of residue R is terephthalic acid or, alternatively, a mixture of terephthalic and isophthalic acids.

In one embodiment, the polyester resin comprises one or more resins selected from linear polyester resins, branched polyester resins and copolymeric polyester resins.

Suitable linear polyester resins include, e.g., poly(alkylene phthalate)s such as, e.g., poly(ethylene terephthalate) (“PET”), poly(butylene terephthalate) (“PBT”), poly(propylene terephthalate) (“PPT”), poly(cycloalkylene phthalate)s such as, e.g., poly(cyclohexanedimethanol terephthalate) (“PCT”), poly(alkylene naphthalate)s such as, e.g., poly(butylene-2,6-naphthalate) (“PBN”) and poly(ethylene-2,6-naphthalate) (“PEN”), poly(alkylene dicarboxylate)s such as, e.g., poly(butylene dicarboxylate).

Suitable copolymeric polyester resins include, e.g., polyesteramide copolymers, cyclohexanedimethanol-terephthalic acid-isophthalic acid copolymers and cyclohexanedimethanol-terephthalic acid-ethylene glycol (“PETG”) copolymers.

In another embodiment, the polyester resin has an intrinsic viscosity of from about 0.4 to about 2.0 dl/g as measured in a 60:40 phenol/tetrachloroethane mixture at 25°-30° C.

CATALYST COMPONENT. It has been noted that there is a correlation between the drop in molecular weight of polycarbonate/polyester blends as well as deteriorated physical properties, with an increase in the amount of catalysts used in the melt extrusion reaction.

In one embodiment the claimed invention uses in the range of about 50 to 2000 ppm of the ester-interchange catalyst. In one embodiment the amount of catalyst used is in the range of about 50 to about 1000 ppm. In yet another embodiement of the present invention the amount of catalyst employed is in the range of about 50 ppm to about 300 ppm. If used, the catalyst can be any of the catalysts commonly used in the prior art such as alkaline earth metal oxides such as magnesium oxides, calcium oxide, barium oxide and zinc oxide; alkali and alkaline earth metal salts; a Lewis catalyst such as tin or tinanium compounds; a nitrogen-containing compound such as tetra-alkyl ammonium hydroxides used like the phosphonium analogues, e.g., tetra-alkyl phosphonium hydroxides or acetates. The Lewis acid catalysts and the catalysts can be used simultaneously.

Inorganic compounds such as the hydroxides, hydrides, amides, carbonates, phosphates, borates, etc., of alkali metals such as sodium, potassium, lithium, cesium, etc., and of alkali earth metals such as calcium, magnesium, barium, etc., can be cited such as examples of alkali or alkaline earth metal compounds. Examples include sodium stearate, sodium carbonate, sodium acetate, sodium bicarbonate, sodium benzoate, sodium caproate, or potassium oleate.

In one embodiment of the invention, the catalyst is selected from one of phosphonium salts or ammonium salts (not being based on any metal ion) for improved hydrolytic stability properties. In another embodiment of the invention, the catalyst is selected from one of: a sodium stearate, a sodium benzoate, a sodium acetate, and a tetrabutyl phosphonium acetate.

In one embodiment of the present invention the catalysts is selected independently from a group of sodium stearate, zinc stearate, calcium stearate, magnesium stearate, sodium acetate, calcium acetate, zinc acetate, magnesium acetate, manganese acetate, lanthanum acetate, lanthanum acetylacetonate, sodium benzoate, sodium tetraphenyl borate, dibutyl tinoxide, antimony trioxide, sodium polystyrenesulfonate, PBT-ionomer, titanium isoproxide and tetraammoniumhydrogensulfate and mixtures thereof.

STABILIZING ADDITIVES. Stabilizing additives such as catalyst quenchers are used in the present invention to stop the polymerization reaction between the polymers, if not, an accelerated interpolymerization and degradation of the polymers result, resulting in a blend of little value. Stabilizing additives are also known as anti-jumbling agents.

In the thermoplastic compositions which contain a polyester resin and a polycarbonate resin it is preferable to use a stabilizer or quencher material. Catalyst quenchers are agents which inhibit activity of any catalysts which may be present in the resins. Catalyst quenchers are described in detail in U.S. Pat. No. 5,441,997. It is desirable to select the correct quencher to avoid color formation and loss of clarity to the polyester polycarbonate blend. In one embodiment of the invention, the catalyst quenchers are phosphorus containing derivatives, such as organic phosphites as well as esters of phosphorous acid. Examples include diphosphites, which are likely to convert into phosphonates in use; metaphosphoric acid; arylphosphinic and arylphosphonic acids.

The quenchers are generally used in the form of liquids or of solids having a low melting point, which renders their incorporation with the polymer mixture easier. It should be noted that some quenchers, as in the class of phosphites, also provide the blends additional desirable properties, e.g., fire resistance. The favored stabilizers include an effective amount of an acidic phosphate salt; an acid, alkyl, aryl or mixed phosphite having at least one acidic hydrogen; a Group IB or Group IIB metal phosphate salt; a phosphorus oxo acid, a metal acid pyrophosphate or a mixture thereof. The suitability of a particular compound for use as a stabilizer and the determination of how much is to be used as a stabilizer may be readily determined by preparing a mixture of the polyester resin component and the polycarbonate and determining the effect on melt viscosity, gas generation or color stability or the formation of interpolymer. The acidic phosphate salts include sodium dihydrogen phosphate, mono zinc phosphate, potassium hydrogen phosphate, calcium dihydrogen phosphate and the like. The phosphites may be of the formula IV:

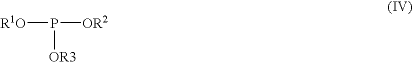

where R1, R2 and R3 are independently selected from the group consisting of hydrogen, alkyl and aryl with the proviso that at least one of R1, R2 and R3 is hydrogen. The phosphate salts of a Group IB or Group IIB metal include zinc phosphate and the like. The phosphorus oxo acids include phosphorous acid, phosphoric acid, polyphosphoric acid or hypophosphorous acid.

The polyacid pyrophosphates may be of the formula V:

M_{zx}H_{y}PₙO₃ₙ₊₁ (V)

wherein M is a metal, x is a number ranging from 1 to 12 and y is a number ranging 1 to 12, n is a number from 2 to 10, z is a number from 1 to 5 and the sum of (xz)+y is equal to n+2. The preferred M is an alkaline or alkaline earth metal.

The most preferred quenchers are oxo acids of phosphorus or acidic organo phosphorus compounds. Inorganic acidic phosphorus compounds may also be used as quenchers, however they may result in haze or loss of clarity. Most preferred quenchers are phosphoric acid, phosphorous acid or their partial esters.

In one embodiment of the invention, the quencher is comprised of the carboxylic acids, i.e., organic compounds the molecule of which comprises at least one carboxy group. In other embodiments, the quencher comprises non-aromatic acids such as stearic acid, or aromatic acids such as terephthalic, trimellitic, trimesic, pyromellitic acids. The quenchers may further be anhydrides such as the anhydride of tetrahydrofuran-tetracarboxylic acid or the anhydrides of aromatic acids comprising at least three carboxy groups, such as trimellitic, pyromellitic, and naphthalenetetracarboxylic acids, such anhydrides being preferably partially hydrolyzed.

In one embodiment of the invention wherein a catalyst is used, an amount of about 25-200% on a molar basis of catalyst quencher is used versus the amount of catalyst added. In a second embodiment wherein no catalyst is used, an amount of up to about 0.002 parts by weight of catalyst quencher per 100 parts by weight of total resin composition can be used. In a third embodiment of the invention, about less than 50 ppm of catalyst quencher is used. Typically, such stabilizers are used at a level of 0.001-10 weight percent and preferably at a level of from 0.005-2 weight percent

It should be noted that the use of catalyst quencher reduces the YI, or the yellowish color of the copolymerized mixture. This has the opposite effect of the use of the catalyst, which increases the YI or the yellow index while providing a positive effect of keeping the haze level down.

Applicants have found that by minimizing/optimizing the amount of catalyst and the feeding of the catalyst quencher used in present invention, Applicants have obtained PC/polyester blends having a single transition temperature (T_{g}), a correlated haze value of 5% or less, improved hydrolytic stability, a stable melt viscosity, and a yellowness index value of less than 10.

OPTIONAL ADDITIVE COMPONENTS. The composition of the present invention may include additional components which do not interfere with the previously mentioned desirable properties but enhance other favorable properties such as anti-oxidants, flame retardants, reinforcing materials, colorants, mold release agents, fillers, nucleating agents, UV light and heat stabilizers, lubricants, and the like.

Additionally, additives such as antioxidants, quenchers, minerals such as talc, clay, mica, barite, wollastonite and other stabilizers including but not limited to UV stabilizers, such as benzotriazole, supplemental reinforcing fillers such as flaked or milled glass, and the like, flame retardants, pigments or combinations thereof may be added to the compositions of the present invention.

The range of composition of the blends of the present invention is from about 10 to 90 weight percent of the polycarbonate component, 90 to about 10 percent by weight of the polyester component. In one embodiment, the composition comprises about 25-75 weight percent polycarbonate and 75-25 weight percent of the polyester component. In a third embodiment, the composition comprises about 40-60 weight percent polycarbonate and 60-40 weight percent of the polyester component.

PROCESSING. The blend of the present invention, polycarbonate, polyester, and optional additives thereof, is polymerized by extrusion at a temperature ranging from about 225 to 350° C. for a sufficient amount of time to produce a copolymer characterized by a single Tg.

In the present invention, either a single or twin screw extruder can be used. The extruder should be one having multiple feeding points, allowing the catalyst quencher to be added at a location down-stream in the extruder.

In one embodiment the process is a one pass process wherein the catalyst is added at the beginning of the extrusion process via an upstream feeding point, and the acidic quencher is added at the later portion of the extruder process via a downstream feeding point. Since the catalyst quencher is added downstream after the completion of the reaction, it has little or no impact on the haze of the composition.

In one embodiment the catalyst is added at the beginning of the extrusion process via an upstream feeding point. The colored clear blends are then reloaded into the extruder and the acidic quencher is added to the blend in the second pass via a downstream feeding point. Since the catalyst quencher is added downstream after the completion of the reaction, it has little or no impact on the haze of the composition. The residence time can be up to about 45 to 90 minutes.

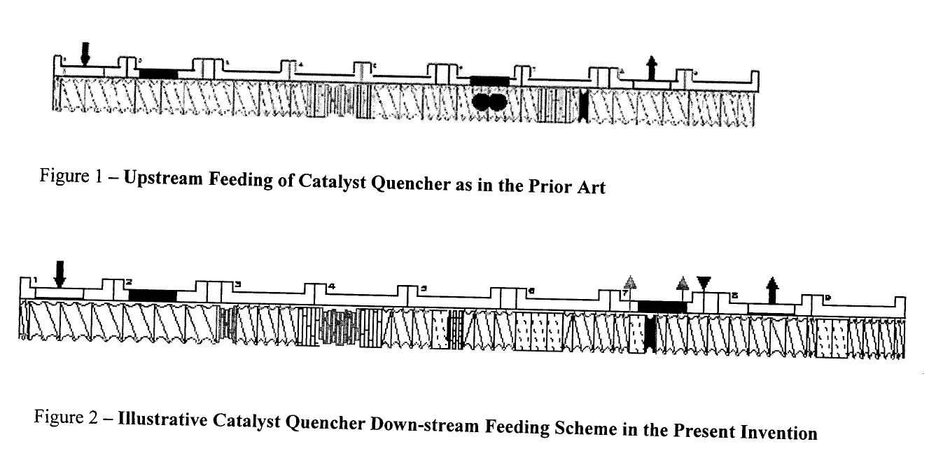

In the illustrative drawings, FIGS. 1-2 are schematic representations of the continuous extruder design in the prior art, and the present invention (FIG. 2). The extruders are assembled by connecting segmented modules (or barrels) with threaded rods. In the present invention, the catalyst quencher is fed downstream between barrels 7 and 8.

In one embodiment, the residence time is about 5 seconds to 10 minutes. In a second embodiment, it is 15 seconds to 5 minutes. In a third embodiment, it is 15 seconds to 3 minutes. In embodiments wherein no catalyst is used, the residence time is at the high end of the range.

APPLICATIONS. The compositions of the present invention can be formed into useful articles by any of the known methods for shaping thermoplastics, including extrusion, thermoforming, blow molding, compression molding, and injection molding. In one embodiment, the compositions are shaped into house ware objects such as food containers and bowls.

EXAMPLES. The following examples illustrate the present invention, but are not meant to be limitations to the scope thereof. In the examples, the following properties are measured:

1) Glass transition temperatures: using a Perkin-Elmer DSC-II instrument, or on any other instrument known to those skilled in this art.

2) Sound dampening: this is a subjective test, recording the noise generated as “solid” or “hollow” when a part molded from a PC/polyester blend, for example, a bowl, is dropped from a distance of about 4 feet onto a wood surface. There is a correlation between a “solid” noise produced of the molded part and the sound dampening property of the polymer composition forming the part.

3) Yellow index or YI: Measured on a Gardner Colorimeter model XL-835.

4) % Transmission and Haze: Determined in accordance with test method ASTM D-1003.

5) Chemical resistance: Extruded test piece (thickness=2.5 mm) was secured in 1% distortion jig and immersed in an aqueous solution of 1% detergent at 85° C. for one hour. The sample was then inspected and evaluated visually.

6) Long term retention of optical properties. The Haze and YI were measured after the accelerated aging test as prescribed in test method ASTM D1925 for YI and ASTM D-1003 for Haze values.

7) Impact strength. Un-notched Izod ASTM D256.

8) Melt volume rate. Measured per ISO Standard 1133, 265° C., 240 seconds, 2.16 Kg, and 0.0825 inch orifice.

Examples 1-24. In these example, 75 weight percent of polycarbonate available from General Electric Company as Lexan® polycarbonate resin 105 was blended with a Glycol Modified Polyethylene Terephthalate PETG from SK Chemicals under the name Skygreen S2008, and varying levels of different catalysts. The blends were compounded at 250° C. on a WP25 mm co-rotating twin screw extruder, yielding a pelletized composition. The H₃PO4 was used as a quencher in a molar 2:1 ratio of catalyst to quencher. The resulting pellets were dried for at least six hours at 100° C. before injection molding into ASTM/ISO test specimens on an 80 ton, injection molding machine operated at a temperature of about 280° C. Samples molded from the blends were tested for optical properties like % Transmission, % haze and yellow index. The results are as indicated below in Table 1.

TABLE 1

| | | amount | % Transmission | % haze | YI |
|---|---|---|---|---|---|
| Example | Catalyst | (ppm) | @2.5 mm | @2.5 mm | @2.5 mm |
| 1 | Sodium Stearate | 25 | | 23 | — |
| 2 | Sodium Stearate | 50 | | 3.3 | 5.1 |
| 3 | Sodium Stearate | 100 | | 4.3 | 6 |
| 4 | Sodium Stearate | 200 | 77.2 | 5.5 | 13.0 |
| 5 | Sodium Stearate | 400 | 77.2 | 5.8 | 15.0 |
| 6 | Zinc Stearate | 200 | 80.9 | 5.8 | 9.7 |
| 7 | Zinc Stearate | 400 | 73.4 | 6.3 | 16.8 |
| 8 | Calcium Stearate | 800 | 72.9 | 9.7 | 15.0 |
| 9 | Magnesium Stearate | 200 | 81.6 | 2.4 | 10.9 |
| 10 | Sodium Acetate | 37 | | 13 | — |
| 11 | Sodium Acetate | 75 | | 2.5 | 4.5 |
| 12 | Sodium Acetate | 150 | | 2.8 | 6.2 |
| 13 | Calcium Acetate | 200 | 84.5 | 9.8 | 6.6 |
| 14 | Calcium Acetate | 400 | 84.8 | 22.5 | 6.3 |
| 15 | Manganese Acetate | 400 | 80.8 | 2.0 | 11.6 |
| 16 | Zinc Acetate | 2000 | 80.9 | 7.1 | 14.3 |
| 17 | Tetrabutylphosphonium acetate | 77 | | 1.5 | 2.8 |
| 18 | Tetrabutylphosphonium acetate | 191 | | 2.3 | 3.2 |
| 19 | Lathanum Acetylacetonate | 200 | 80.0 | 4.9 | 12.6 |
| 20 | Sodium Benzoate | 200 | 83.9 | 19.9 | 8.7 |
| 21 | Sodium Benzoate | 400 | 81.7 | 37.5 | 11.7 |
| 22 | Sodium Tetraphenyl borate | 200 | 82.9 | 5.3 | 9.9 |
| 23 | Dibutyl Tinoxide | 200 | 86.2 | 2.7 | 4.2 |
| 24 | Dibutyl Tinoxide | 400 | 85.3 | 3.5 | 6.9 |

From Table 1 it is seen that a very small amount of stearates of sodium, zinc and magnesium, acetates of sodium, calcium, magnesium, manganese, lanthanum acetylcaetonate, sodium benzoate, sodium tetraphenyl borate and dibutyl tin oxide are enough to produce a clear PC/PETG. However larger amount of catalyst example calcium stearate, zinc acetate is needed to compatibilize the blend. The color of the first pass blend was noticed as pale yellow due to the presence of un-reacted catalyst. The blend was subjected for second pass using H₃PO₄ as a quencher to obtain a colorless PC/PETG blend. Dibutyltinoxide produced a very clear blend. Depending on the catalyst level the Haziness of the blend varies. Magnesium stearate, manganese stearate, dibutyl tinoxide, manganese acetate generates blend with very low value of haziness. These blends prepared using all different catalyst reported here are transparent but slightly yellow. The yellowness index varies with different catalyst. Sodium stearate, lanthanum acetyl acetonate, manganese acetate, sodium benzoate and sodium tetraphenyl borate generates yellowish blend with yellowness value more than 12. Out of these blends, blend with catalyst dibutyl tinoxide has very less YI value (4.2). In all examples, the blends have a single glass transition temperature in the range of about 115-125° C.

Examples 25-28. In the examples, blends were made with 75 weight percent of polycarbonate available from General Electric Company as Lexan® polycarbonate resin 105 was blended with a Glycol Modified Polyethylene Terephthalate PETG from SK Chemicals under the name Skygreen S2008, and varying levels of different catalysts. Phosphoric acid was used as a catalyst quencher in an amount of 50 ppm. In all examples, the blends have a single glass transition temperature of 130° C.

In examples 25, 27 and 28, a WP92 mm co rotating twin screw extruder was used with a screw design as shown in FIG. 2, which allows for the downstream feeding of the catalyst quencher (added at barrel 8). In comparative example 28, the same co rotating twin screw extruder was used with a different screw design as shown in FIG. 1, which does not allow for the downstream feeding of the catalyst quencher. Furthermore, comparative example 10 requires a two-pass run with the quencher being added in the second pass. Adding the quencher in the first pass (upstream feeding as opposed to downstream feeding as in the present invention) will give a final product being hazy or opaque. Samples molded from the compositions of the examples were tested, and the results are shown in Table 2.

TABLE 2

| | | Extrusion | Amount | % haze | |
|---|---|---|---|---|---|
| Example | Catalyst | Pass | (ppm) | @ 2.5 mm | MVR |
| 25 | Sodium Stearate | 1 | 45 | <5 | 15 |
| 26 | Sodium Stearate | 2 | 90 | <5 | — |
| 27 | Sodium Acetate | 1 | 21 | <5 | 16 |
| 28 | Sodium Benzoate | 1 | 20 | <5 | 16 |

Examples 29-34. In order to investigate the robustness of the blending technique as well as the catalysts for the PC/PETG blends, another PETG source purchased from Eastman chemical company also included for the current invention. This PETG grade is different from the previous PETG (SK Chemicals) in terms of residual catalysts and additives. The blends were prepared using the same two-pass procedure described for the SK grade PETG. The properties of blends obtained from Eastman PETG using different catalysts are shown in Table 3

TABLE 3

| | | amount | |
|---|---|---|---|
| Example | Catalyst | (ppm) | Tg ° C. |
| 29 | Sodium Stearate | 200 | 125 |
| 30 | Magnesium Stearate | 800 | 119 |
| 31 | Magnesium Acetate | 800 | 114 |
| 32 | Calcium Acetate | 800 | 130 |
| 33 | Dibutyl Tinoxide | 100 | 120 |
| 34 | Dibutyl Tinoxide | 200 | 120 |

Table 3 results suggest that the compatibilization effect of typical transesterification catalysts in the PC/PETG blend formation highly dependent on the type of the PETG grade used. While small amount of dibutyl tinoxide and sodium stearate are enough for blending Eastman PETG with PC similar to SK grade, more amount of magnesium stearate, magnesium and calcium acetate is required for blending PC with Eastman PETG when compared to SK grade.

Example 35-40. Single pass extrusion process employed for the PC/PETG blend formation. To check the robustness of catalyst with different polyesters (PETG)sources, Eastman and SK grade are used and the results are reported in the Table 4. PC, PETG and the catalysts were added in the up stream of the extruder and the resultant optically clear PC/PETG blend was quenched by adding H₃PO₄ down stream.

TABLE 4

| | | | Amount | % Transmission | % haze | YI |
|---|---|---|---|---|---|---|
| Example | PETG Type | Catalyst | (ppm) | @2.5 mm | @2.5 mm | @2.5 mm |
| 35 | SK Grade | Sodium Stearate | 200 | 86.4 | 3.0 | 6.4 |
| 36 | SK Grade | Calcium Acetate | 200 | 87.7 | 11.3 | 4.6 |
| 37 | SK Grade | Dibutyl Tinoxide | 200 | 86.5 | 6.0 | 5.6 |
| 38 | Eastman Grade | Sodium Stearate | 200 | 86.9 | 2.7 | 5.3 |
| 39 | Eastman Grade | Calcium Acetate | 800 | 86.2 | 40.2 | 4.7 |
| 40 | Eastman Grade | Dibutyl Tinoxide | 200 | 87.6 | 6.1 | 4.1 |

The data in table 4 suggests that the single pass process is as effective as the two pass extrusion for the formation of clear and transparent PC/PETG blends.

The visual properties like % Transmission and % Haze and mechanical properties like Heat Distortion temperature (HDT), Flexural Strength and Modulus, and tensile strength were measured. These properties are reported in Table 5. The tensile and Flexural properties were measured using Universal Testing Machine (UTM).

The blends reported in this invention using different catalysts have similar mechanical properties. The visual properties varies with different catalyst type and amount of catalyst used. All the blends with catalyst reported in table 5, shows more than 75% transparency. The blends obtained using dibutyltin oxide and calcium acetate catalyst shows more than 85% transparency. The mechanical properties such as flexural, tensile properties and HDT are also reported in table 5. The flexural modulus of the blends with all these catalysts is equivalent. The blends with sodium stearate, dibutyltin oxide, zinc stearate catalyst yields brittle blends. Calcium, zinc and magnesium acetates generate blends, which are ductile. The HDT values of these blends are also close to 100° C. The PC/PETG blend with calcium acetate is ductile

TABLE 5

| | | | Flexural | | | Tensile | | | |
|---|---|---|---|---|---|---|---|---|---|
| | | | Flex | Flex | | TS@ | TS@ | Yield | |
| | Transmission | HDT | Modulus | Stress | Ductile/ | Yield | Break | Strain | Elongation |
| Example | % | (° C.) | (Gpa) | (Mpa) | Brittle | (Mpa) | (Mpa) | % | % |
| 4 | 77.2 | 96.5 | 2.6 | 47.4 | brittle | | | | |
| 5 | 77.2 | | | | brittle | | 21.2 | | 1.4 |
| 6 | 80.9 | | 2.5 | 102.8 | ductile | 64.9 | 44.6 | 5.7 | 19.5 |
| 7 | 73.4 | | 2.6 | 103.9 | brittle | | 29.6 | | 1.7 |
| 9 | 81.6 | 101.0 | 2.5 | 102.5 | ductile | 66.3 | 47.2 | 5.8 | 35.4 |
| 8 | 72.9 | | 2.5 | 102.2 | ductile | 65.6 | 45.7 | 5.5 | 8.7 |
| 13 | 84.5 | 103.4 | 2.4 | 101.7 | ductile | 66.3 | 47.3 | 6.0 | 39.6 |
| 14 | 84.8 | | 2.4 | 100.5 | ductile | 65.2 | 46.6 | 5.6 | 49.3 |
| 15 | 80.8 | 100.4 | 2.4 | 101.4 | ductile | 66.0 | 49.2 | 6.1 | 54.3 |
| 16 | 80.9 | 97.7 | 2.5 | 62.5 | brittle | | 41.2 | | 2.0 |
| 19 | 80.0 | | 2.5 | 102.6 | ductile | 65.3 | 45.5 | 5.7 | 37.1 |
| 20 | 83.9 | | 2.6 | 49.7 | brittle | | 21.6 | | 1.3 |
| 21 | 81.7 | | | | brittle | | 16.5 | | 1.1 |
| 22 | 82.9 | | 2.6 | 96.9 | brittle | | 16.5 | | 1.1 |
| 23 | 86.2 | 97.8 | 2.6 | 48.5 | brittle | | 18.4 | | 1.0 |
| 24 | 85.3 | | | | brittle | | | | |

even at −10° C. and −20° C.

While the invention has been illustrated and described in typical embodiments, it is not intended to be limited to the details shown, since various modifications and subsitutions can be made without departing in any way from the spirit of the present invention. It is, therefore, to be understood that the appended claims are intended to cover all such modifications and changes as fall within the true spirit of the invention.

1. A process for preparing a transparent polyester/polycarbonate composition comprising:
reacting together at a first location in a molten state, at a temperature between about 225 to about 350° C., a polycarbonate resin and a polyester resin, and in the presence of an effective amount of a catalyst,
adding to the molten mixture at a location downstream from the first location, an effective amount of an acidic stabilizing additive,
kneading said stabilizing additive and said molten stream for a resulting copolymer blend having a single glass transition temperature.

2. The process of claim 1, wherein said catalyst is selected from the group consisting of alkali metal and alkaline earth metal salts of aromatic dicarboxylic acids, alkali metal and alkaline earth metal salts of aliphatic dicarboxylic acids, Lewis acids, metal oxides, their coordination complexes and mixtures thereof.

3. The process of claim 1, wherein said polyester is selected independently from a group consisting of reacting an aromatic dicarboxylic ester or acid with an aliphatic diol.

4. The process of claim 1, wherein said polycarbonate is an aromatic polycarbonate.

5. The process of claim 1, wherein said transparent polyester/polycarbonate composition is in a range of about 10 to about 90 percent by weight of polyester and about 90 to about 10 percent by weight of polycarbonate.

6. The process of claim 1, wherein said acidic stabilizing additive is selected from the group consisting of: phosphorus oxo acids, acid organo phosphates, acid organo phosphites, diphosphites, esters of phosphoric acid, salts of phosphoric acids or mixtures thereof.

7. The process of claim 1, wherein said stabilizing additive is present at a level from about 0 to about 5 percent by weight based on the total weight of said composition.

8. The process of claim 1, wherein the said process is a two pass process wherein said reacting step as set forth in claim 1 produces a resulting reacted product, said resulting reacted product is solidified to complete a single pass and said resulting solidified product is subsequently processed according to a second pass to a molten state prior to the adding step as set forth in claim 1.

9. A process for preparing transparent polyester/aromatic polycarbonate composition, said process comprising:
reacting together at a first location in a molten state at a temperature between about 225 to about 350° C., a polycarbonate resin and a polyester resin and in the presence of an effective amount of a catalyst,
adding to the molten mixture at a location downstream from the first location, an effective amount of an acidic stabilizing additive,
kneading said stabilizing additive and said molten stream for a resulting copolymer blend having a single glass transition temperature.

10. The process of claim 9, wherein said catalyst is selected from the group consisting of alkali metal and alkaline earth metal salts of aromatic dicarboxylic acids, alkali metal and alkaline earth metal salts of aliphatic dicarboxylic acids, Lewis acids, metal oxides, their coordination complexes and mixtures thereof.

11. The process of claim 9, wherein said catalyst is present in less than about 300 ppm.

12. The process of claim 9, wherein said polyester is a poly(ethylene terephthalate), a poly(1,4-butylene terephthalate), a cyclohexanedimethanol-terephthalic acid-ethylene glycol, a poly(cyclohexanedimethanol terephthalate), or a poly(alkylene naphthalate).

13. The process of claim 9, wherein the said process is a two pass process wherein said reacting step as set forth in claim 9 produces a resulting reacted product, said resulting reacted product is solidified to complete a single pass and said resulting solidified product is subsequently processed according to a second pass to a molten state prior to the adding step as set forth in claim 9.

14. The process of claim 9, wherein said polycarbonate comprises repeating units of the formula 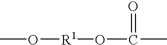
wherein R¹ is a divalent aromatic radical derived from a dihydroxyaromatic compound of the formula HO—R¹—OH.

15. The process of claim 9, wherein said transparent polyester/polycarbonate composition is in a range of about 10 percent to about 90 percent by weight of polyester and 90-10 percent by weight of polycarbonate.

16. The process of claim 9, wherein said acidic stabilizing additive is selected from the group consisting of consisting of: phosphorus oxo acids, acid organo phosphates, acid organo phosphites, diphosphites, esters of phosphoric acid, salts of phosphoric acids arylphosphonic acid, arylacid phosphate metal salts, acidic phosphite metal salts or mixtures thereof.

17. The process of claim 9, wherein said catalyst is present at a level from about 5 ppm to about 2000 ppm percent by weight based on the total weight of said composition.

18. The process of claim 9, wherein said acid stabilizing additive is present at a level from about 0 to about 2 percent by weight based on the total weight of said composition.

19. An article comprising the composition of claim 9.

20. A process for preparing a transparent polyester/aromatic polycarbonate composition, said process comprising:
melt mixing together at a first location in a molten state, at a temperature between about 225 to 350° C., a polycarbonate resin and a polyester resin, in presence of an effective amount of a catalyst,
adding at a location downstream from the first location, an effective amount of an acidic stabilizing additive,
kneading said stabilizing additive and said molten stream for a resulting copolymer blend having a single glass transition temperature.

21. The process of claim 20, wherein said polyester is a poly(ethylene terephthalate), a poly(1,4-butylene terephthalate), a cyclohexanedimethanol-terephthalic acid-ethylene glycol, a poly(cyclohexanedimethanol terephthalate), or a poly(alkylene naphthalate).

22. The process of claim 20, wherein said polyester is a poly (ethylene -co-cyclohexylenedimethylene) terephthalate.

23. The process of claim 20, wherein said polycarbonate comprises repeating units of the formula 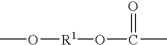
wherein R¹ is a divalent aromatic radical derived from a dihydroxyaromatic compound of the formula HO—R¹—OH.

24. The process of claim 25, wherein the dihydroxyaromatic compound from which R1 is derived is bisphenol A.

25. The process of claim 20, wherein said catalyst is selected from the group consisting of sodium stearate, zinc stearate, calcium stearate, magnesium stearate, sodium acetate, calcium acetate, zinc acetate, magnesium acetate, manganese acetate, lanthanum acetate, lanthanum acetylacetonate, sodium benzoate, sodium tetraphenyl borate, dibutyl tinoxide, antimony trioxide, sodium polystyrenesulfonate, PBT-ionomer, titanium isoproxide and tetraammoniumhydrogensulfate and mixtures thereof.

26. The process of claim 20, wherein said catalyst is present in less than about 50 to 2000 ppm.

27. The process of claim 20, wherein said catalyst is present in less than about 50 to 1000 ppm.

28. The process of claim 20, wherein said catalyst is present in less than about 50 to 300 ppm.

29. The process of claim 20, wherein said transparent polyester/polycarbonate composition is in a range of about 10-90 percent by weight of polyester and 90-10 percent by weight of polycarbonate.

30. The process of claim 20, wherein said transparent polyester/polycarbonate composition is in a range of about 25-75 percent by weight of polyester and 75-25 percent by weight of polycarbonate.

31. The process of claim 20, wherein said transparent polyester/polycarbonate composition is in a range of about 25 percent by weight of polyester and 75 percent by weight of polycarbonate.

32. The process of claim 20, wherein said acidic stabilizing additive is selected from the group consisting of phosphorous compounds consisting of: phosphorus oxo acids, acid organo phosphates, acid organo phosphites, diphosphites, esters of phosphoric acid, salts of phosphoric acids arylphosphonic acid, arylacid phosphate metal salts, or mixtures thereof.

33. The process of claim 20, wherein said acidic stabilizing additive is phosphoric acid.

34. The process of claim 20, wherein said stabilizing additive is present at a level from about 0 to about 2 percent by weight based on the total weight of said composition.

35. The process of claim 20, wherein said stabilizing additive is present at a effective amount.

36. The process of claim 20, wherein the said process is a two pass process wherein said reacting step as set forth in claim 20 produces a resulting reacted product, said resulting reacted product is solidified to complete a single pass and said resulting solidified product is subsequently processed according to a second pass to a molten state prior to the adding step as set forth in claim 20.

37. The process of claim 20, wherein the amount of catalyst is in the range of about 20 ppm to about 50 ppm the said polyester/aromatic polycarbonate composition is ductile.

38. The process of claim 20, wherein the amount of catalyst is in the range of greater than about 100 ppm the said polyester/aromatic polycarbonate composition is brittle.

39. The process of claim 37 where in said catalyst is selected independently from the group consisting of sodium stearate, calcium acetate, zinc acetate, magnesium acetate and mixtures thereof.

40. The process of claim 38 where in said catalyst is sodium stearate, dibutyltin oxide, zinc stearate and mixtures thereof.

41. The polyester/aromatic polycarbonate composition of claim 30, wherein said composition has a yellowness index of about less than 20.

42. The polyester/aromatic polycarbonate composition of claim 30, wherein said composition transmits about greater than 70 percent light in the region of about 250 nm to about 300 nm.

43. The polyester/aromatic polycarbonate composition of claim 30, wherein said composition has a haze value about less than 30.

44. An article comprising the composition of claim 30.
